(19) United States
(12) Patent Application Publication
(10) Pub. No.: US 2005/0225920 A1
(43) Pub. Date: Oct. 13, 2005

(54) Electrical circuit comprising an electromagnetic relay and a switching arrangement which is mounted in parallel to a contact of the magnetic relay

(75) Inventor: Klaus Dunemann, Falkensee (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/502,436

(22) PCT Filed: Jan. 8, 2003
(86) PCT No.: PCT/DE03/00070

§ 371 Date: Jul. 23, 2004

(30) Foreign Application Priority Data
Jan. 24, 2002 (DE) 102 03 682.9

(51) Int. Cl. H01H 47/00

(52) U.S. Cl. 361/160

(57) ABSTRACT

The invention relates to an electrical circuit (1) comprising an electromagnetic relay (4) and a switching arrangement (5), the outputs (A1, A2) of said switching arrangement being mounted in parallel to a contact (4a) of the electromagnetic relay (4). A control system (2) is connected to the coil (4b) of the relay (4) and the switching arrangement (5). The aim of the invention is to create one such circuit in a relatively interference-free manner. To this end, a voltage detection unit (6) is arranged between the control system (2) and the coil (4b). A first switching signal (S1) is produced, at a switching-on command, by means of a control unit (7) which is arranged downstream from the voltage detection device (6), said signal short-circuiting the outputs (A1, A2) of the switching arrangement (5). At the end of the switching-on command, the outputs (A1, A2) of the switching arrangement (5) remain short-circuited until the contact (4a) of the relay (4) is opened. In the absence of a switching-on command, a second switching signal (S2) is produced by means of the voltage detection device (6) and the control unit (7), eliminating the short-circuiting of the outputs (A1, A2) of the switching arrangement (5).

### CLAIM FOR PRIORITY

This application is a national stage of International Application No. PCT/DE03/00070 which was published on Jul. 31, 2003 and which claims the benefit of priority to German Application No. 102 03 682.9 filed Jan. 24, 2002.

### TECHNICAL FIELD OF THE INVENTION

The invention relates to an electrical switching arrangement having an electromagnetic relay, a switching device, whose outputs are arranged parallel to one contact of the electromagnetic relay, and a control arrangement which is connected to the coil of the electromagnetic relay and to the switching device.

### BACKGROUND OF THE INVENTION

Such an arrangement is disclosed as a so-called instantaneous release unit in the appliance manual “Schutztechnik—Digitaler Oberleitungsschutz 7SA518/519 V3.2” [Protective relaying—digital overhead line protection 7SA518/519 V3.2] issued by Siemens AG, November 1999 (cf. pp. 3-6, R-13 and R-15). This instantaneous release unit serves the purpose of reducing the switch-on time of a downstream protective device. For this purpose, the outputs of a switching arrangement are arranged parallel to one contact of an electromagnetic command relay. Both the switching arrangement and the command relay are connected to a control unit via isolated connecting lines. If the control arrangement emits a switching command, both the contact of the electromagnetic relay and the output of the switching arrangement are short-circuited. The switching arrangement is designed such that its switch-on time is markedly shorter than that of the electromagnetic relay, with the result that the switch-on time of the switching arrangement and not that of the electromagnetic relay defines the switch-on time of the downstream protective device.

### SUMMARY OF THE INVENTION

The invention improves upon the above-described switching arrangement in terms of its lack of sensitivity with respect to electromagnetic interference and, on the other hand, markedly reducing the load on the relay contact owing to arc flashovers.

In one embodiment of the invention, there is a voltage detection device being arranged between the control arrangement and the coil of the electromagnetic relay, the voltage detection device instructing, in the event of a switch-on command being emitted by the control arrangement, a downstream drive unit to emit a switching signal which short-circuits the switching device on the output side, maintaining, when the switch-on command is ended, the switching signal until the contact of the electromagnetic relay is opened, and instructing, in the event of there being no switch-on command, the drive unit to emit a second switching signal which opens the switching device on the output side. By this means it is possible both to ensure a rapid switch-on time of downstream devices and to protect the contact of the relay by the electrical power being drawn completely by the switching device when the relay contact is opened. In addition, the arrangement according to the invention reliably prevents the outputs of the switching arrangement from being inadvertently short-circuited owing to external interference and thus prevents downstream devices from being driven in an undesired manner when there is no switch-on command for the relay.

One advantageous emboidment of the arrangement according to the invention is the voltage detection device having a rectifier circuit which is connected on the input side to the control arrangement and the coil of the electromagnetic relay and is connected on the output side to the drive unit via a comparator. In this case, both in the event of a switch-on command from the control arrangement being present and in the event of a voltage being produced by induction in the coil of the electromagnetic relay during the switch-off procedure, the downstream comparator receives, via the rectifier circuit, a clear signal which instructs the comparator to drive the downstream drive unit such that it short-circuits the switching device at the beginning of a switch-on command and maintains the short-circuited state of the switching device for a specific period of time when the switch-on command is ended.

A voltage is advantageously continuously applied to one input of the comparator. When selecting a voltage such that it has the opposite polarity to the voltage emitted to the comparator by the rectifier circuit, it is possible to achieve the situation in which the comparator emits a clear signal to the downstream drive unit which instructs said drive unit to open the switching device.

In one advantageous embodiment of the arrangement according to the invention, the drive unit has two signal conversion elements driven in phase opposition in such a way that in each case one signal conversion element is active and one signal conversion element is inactive.

This means that it is easily possible, in the case of a first signal emitted by the comparator, for the drive unit to be instructed to close the switching device, and, in the case of a second signal emitted by the comparator having the opposite mathematical sign to the first signal, for the drive unit to be instructed to open the switching device. Depending on the mathematical sign of the signal emitted by the comparator, either one or the other signal conversion element is driven in this embodiment.

A further advantageous embodiment of the arrangement according to the invention provides for the outputs of the respectively inactive signal conversion element to be short-circuited via the respectively active signal conversion element. The respective short-circuiting of the signal conversion element which at that time is not emitting a signal further reduces the susceptibility of the arrangement to electromagnetic interference.

The signal conversion elements may advantageously be in the form of voltage transformers.

Alternatively, the signal conversion elements may advantageously be in the form of photovoltaic generators.

The switching device advantageously has at least one MOS transistor. This makes it possible to provide the required switching power at a low drive power after a relatively short switch-on time.

A further advantageous embodiment of the switching arrangement according to the invention provides for the switching device to operate bi-directionally. This makes it possible for both direct currents and alternating currents to be connected to the output of the switching arrangement.

### BRIEF DESCRIPTION OF THE DRAWINGS

The invention is described in more detail below with reference to the drawing which illustrates one exemplary embodiment of the arrangement according to the invention, in which:

FIG. 1 shows a block circuit diagram according to an embodiment of invention.

### DETAILED DESCRIPTION OF THE INVENTION

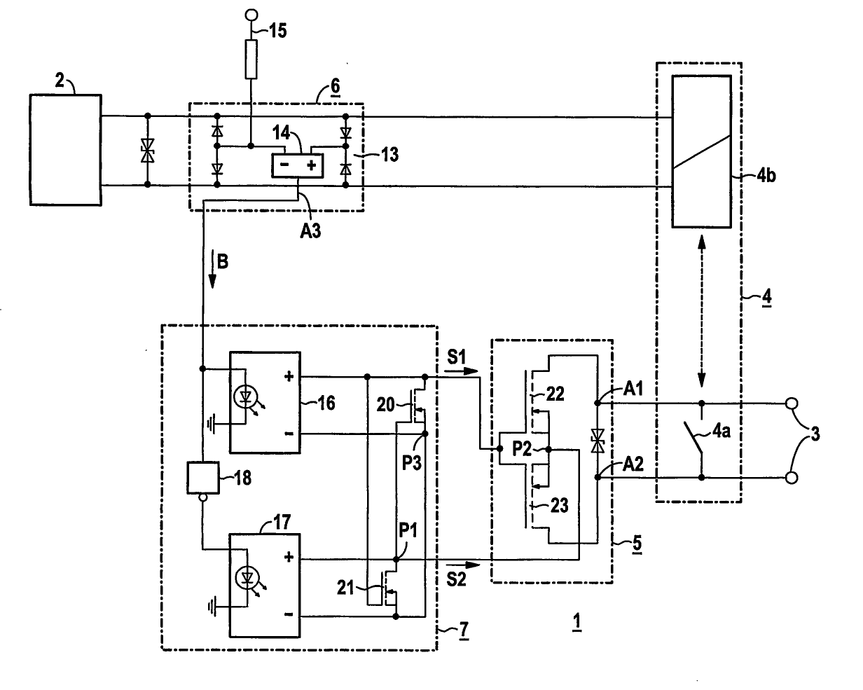

FIG. 1 illustrates a switching arrangement 1 has a control arrangement 2 which is used to switch on a device (not illustrated in the figure) which is connected to outputs 3 of the switching arrangement 1. The outputs 3 of the switching arrangement 1 are arranged parallel to one contact 4a of an electromagnetic relay 4 and to the output of a switching device 5. The coil 4b of the electromagnetic relay 4 is connected directly to the control arrangement 2. A voltage detection device 6, whose output is connected to the switching device 5 via a drive unit 7, is located between the control arrangement 2 and the electromagnetic relay 4.

The arrangement functions as follows: If a switch-on command is emitted by the control arrangement 2, the coil 4b of the electromagnetic relay 4 is excited and closes the contact 4a. Owing to the mechanical inertia of the contact 4a, the electromagnetic relay 4 has a switch-on time which is usually greater than 5 ms. At the same time as the coil 4b of the electromagnetic relay 4, the voltage detection device 6 receives the switch-on command from the control arrangement 2. The voltage detection device 6 passes an actuating signal B on to the drive unit 7 in which a first switching signal S1 is generated, as a result of which the outputs A1 and A2 of the switching device 5 are short-circuited. Since the switching device 5 generally comprises electronic components, it has a markedly shorter switch-on time than the electromagnetic relay 4. When the switch-on command is emitted by the control arrangement 2, first of all the switching device 5 thus short-circuits its outputs A1 and, A2 and draws the full power for driving the device connected to the outputs 3. As soon as the contact 4a of the relay 4 is closed, a significant proportion of the power may be passed through the closed contact 4a.

When the switch-on command emitted by the control arrangement 2 is ended, the magnetic field in the coil 4b of the electromagnetic relay 4 is dissipated. As a result, a back-e.m.f. is induced at the inputs of the coil 4b and is detected by the voltage detection device 6. The induced voltage is applied until the magnetic field in the coil 11 has completely dissipated and the contact 4a of the electromagnetic relay 4 is thus opened. As long as the induced voltage is applied, by means of the voltage detection device 6 the actuating signal B at the drive unit 7 and thus the switching signal S1 for short-circuiting the outputs A1 and A2 of the switching device 5 are maintained. As the contact opens, an arc is prevented from forming at the contact 4a of the electromagnetic relay 4 by the fact that the current can continue to flow via the closed output of the switching device 5. When the magnetic field has dissipated and the contact 4a of the electromagnetic relay 4 is completely open does the switching device 5 also reverse the short circuit at its outputs A1 and A2.

If the control arrangement 2 does not emit or maintain a switch-on command, a further switching signal S2 is emitted by the voltage detection device 6 via the drive unit 7 to the switching device 5 for the purpose of opening the outputs A1 and A2 of the switching device 5 or for the purpose of keeping them open. This prevents the switching device 5 from being inadvertently switched on owing to electromagnetic interference.

The ways in which the voltage detection device 6, the drive unit 7 and the switching device 5 function will be explained in more detail below with reference to the figure. The voltage detection device 6 includes a rectifier circuit 13 and a comparator 14. Both in the event of a switch-on command and in the event of an induced voltage being present, the rectifier circuit 13 provides a positive voltage across the comparator module 14 which thereupon likewise emits a so-called “high” signal, i.e. a positive back-e.m.f. at its output A3. If neither a switch-on command nor an induced voltage are present, a negative voltage takes effect at a further terminal 15 of the comparator 14; the comparator 14 thus emits a negative voltage at its output A3. The negative voltage at the terminal 15 is in this case of such a value that it is smaller than the positive voltage emitted by the rectifier, circuit in the event of a switch-on command from the control arrangement 2.

Two signal conversion elements 16 and 17, which are connected precisely in phase opposition with the aid of an inverter 18 to the output A3 of the comparator 14, are located in the drive unit 7. In the figure, the signal conversion elements 16 and 17 are illustrated as photovoltaic generators. If the comparator 14 provides a high signal, a voltage is generated at the output of the signal conversion element 16. By means of the inverter 18, the signal conversion element 17 receives a “low” signal, i.e. no voltage at its input, and thus does not produce an output voltage. If the comparator 14 emits a low signal at its output, the behavior of the signal conversion elements 16 and 17 is precisely reversed: The signal conversion element 16 does not emit an output voltage, whereas a voltage is applied to the output of the signal conversion element 17. The drive unit 7 also contains transistors 20 and 21, by means of which in each case the outputs of the signal conversion element (16, 17) which does not emit a voltage at its output can be short-circuited. This further reduces the susceptibility to electromagnetic interference.

The switching device 5 may (as illustrated in the figure) have two power MOS transistors 22 and 23 which are connected to one another at their source terminals, whereas the two drain terminals of the power transistors 22 and 23 form the outputs A1 and A2 of the switching device 5. The gate terminals of the power transistors 22 and 23 are connected to one another and to the positive output of the signal conversion element 16, whereas the two source terminals are connected to the positive output of the signal conversion element 17. If the signal conversion element 16 now produces a voltage at its output (this is the case when a high signal is emitted by the comparator 14), a positive voltage is applied at the gate terminals of the power transistors 22 and 23 and the transistors 22 and 23 are turned on. A current can thus flow via the outputs 3 of the switching arrangement 1. If the signal conversion element 17 produces an output voltage (this is the case when a low signal is emitted by the comparator 14), a positive voltage with respect to the gate terminal is applied to the source terminals of the power transistors 22 and 23, and the power transistors block the current flow.

As an alternative to this, it is also possible for the power transistors 22, 23 to be turned off by the source/gate terminals of the power transistors 22, 23 being short-circuited. For this purpose, the connection between the positive output of the signal conversion element 17 and the source terminals of the power transistors 22, 23 between the points P1 and P2 needs to be removed and, in its place, the source terminals of the power transistors 22, 23 at point P2 need to be connected to the source terminal of the transistor 20 at point P3.

1. An electrical switching arrangement comprising:
an electromagnetic relay;
a switching device, having outputs arranged parallel to one contact of the electromagnetic relay;
a control arrangement which is connected to a coil of the electromagnetic relay and the switching device; and
a voltage detection device is arranged between the control arrangement and the coil of the electromagnetic relay, the voltage detection device
instructing, when a switch-on command is emitted by the control arrangement, a downstream drive unit to emit a switching signal which short-circuits the switching device on the output side,
maintaining, when the switch-on command is ended, the switching signal until a contact of the electromagnetic relay is opened, and
instructing, when there is no switch-on command, the drive unit to emit a second switching signal which opens the switching device on the output side.

2. The electrical switching arrangement as claimed in claim 1, wherein
the voltage detection device has a rectifier circuit which is connected on the input side to the control arrangement and the coil of the electromagnetic relay and is connected on the output side to the drive unit via a comparator.

3. The electrical switching arrangement as claimed in claim 2, wherein
a voltage is continuously applied to one input of the comparator.

4. The electrical switching arrangement as claimed in claim 1, wherein
the drive unit has two signal conversion elements driven in phase opposition such that in each case one signal conversion element is active and one signal conversion element is inactive.

5. The electrical switching arrangement as claimed in claim 4, wherein
the outputs of the respectively inactive signal conversion element are short-circuited via the respectively active signal conversion element.

6. The electrical switching arrangement as claimed in claim 4, wherein
the signal conversion elements are voltage transformers.

7. The electrical switching arrangement as claimed in claim 4, wherein
the signal conversion elements are photovoltaic generators.

8. The electrical switching arrangement as claimed in claim 1, wherein
the switching device has at least one MOS transistor.

9. The electrical switching arrangement as claimed in claim 1, wherein
the switching device operates bi-directionally.
